(19) United States
(12) Patent Application Publication
(10) Pub. No.: US 2016/0142409 A1
(43) Pub. Date: May 19, 2016

(54) OPTIMIZED TOKEN-BASED PROXY AUTHENTICATION

(71) Applicant: Microsoft Technology Licensing, LLC, Redmond, WA (US)

(72) Inventors: Adrian Frei, Seattle, WA (US); Tarek B. Kamel, Issaquah, WA (US); Allan Edwin Wetter, Seattle, WA (US); Benjamin R. Vincent, Kirkland, WA (US)

(21) Appl. No.: 14/546,963

(22) Filed: Nov. 18, 2014

(51) Int. Cl. H04L 29/06; H04L 9/32

(52) U.S. Cl. CPC H04L 63/0884; H04L 9/3247; H04L 9/3236

(57) ABSTRACT

Methods, systems, apparatuses, and computer program products are provided for authentication of users in a service-to-service context. At a first service, a user authentication token is received from a client device that was obtained from an identity provider. The user authentication token was received to enable access to the first service by a user. The user is authenticated based on the user authentication token. A second service is determined to be needed to be accessed by the first service on behalf of the user. The user authentication token is converted into a proxy token that is not convertible back to the user authentication token. The proxy token is forwarded from the first service to the second service to enable access to the second service. A response is received by the first service from the second service due to the user having been authenticated based on the proxy token.

### BACKGROUND

An authentication server or service provides a network service that applications use to authenticate the credentials of users. For instance, an authentication server may authenticate the account names and passwords of users. In one common scenario in an authentication system, a first authenticated service A (e.g., a web site or a first tier web application programming interface (API)) may have to act on behalf of a user to access a second authenticated service B (e.g., a second tier web API). An example of this is an email provider that provides web mail (a first authenticated service), and that also allows a user to manage their address book or calendar that is managed by a second authenticated service.

In a token based authentication system, a client obtains an authentication token from an identity provider (IdP). The user provides authentication credentials, and this token is submitted to service A (relying party (RP) of the IdP) to access the resources of service A. This token is typically scoped only to service A (or specific resources of service A), and allows service A to authenticate the user. If service A needs to request data from service B for the user, further authentication has to be performed, and many techniques for such further authentication exist.

For example, server-to-server authentication may be used. According to this technique, service B trusts service A to act on behalf of the user. Thus, service B will authenticate service A through any commonly used mechanism (IP Access Control List, Certificates, OAuth 2.0 with client credentials). Once authenticated, service A will send the user identifier, and service B will provide the user's resources. According to this solution, service B has to fully trust service A with all of its users′resources.

Token forwarding is another technique for authentication between services. According to token forwarding, service A simply forwards the authentication token of the user (scoped to either just service A, or both services A and B) to service B, so that service B will provide its services for the user. This addresses one issue with pure server-to-server authentication because service A can only act on behalf of users that are authenticated to its service. This solution also allows service B to turn around and access service A on behalf of the user, which typically is not intended.

Delegation tokens are another technique. According to this technique, service A requests the user authentication token to authenticate the user at service A, and additionally obtains a delegation token from the IdP, which allows service B to authenticate the user. As such, service A receives the first token (to authenticate the user for itself), as well as a second token (the delegation token that allows service B to authenticate the user) to enable service B to be accessed for the user.

Token exchange is still another technique. To address issues with multiple delegation tokens, a token exchange service can be used. A token exchange service may be operated by the IdP, allowing services to exchange their authentication token for authentication tokens scoped for other services. According to this technique, service A authenticates the user using the authentication token, and then exchanges this authentication token for another authentication token scoped for service B.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer program products are provided for authentication of users in a service-to-service context. At a first service, a user authentication token is received from a client device that was obtained from an identity provider. The user authentication token was received to enable access to the first service by a user. The user is authenticated at the first service based on the user authentication token. A second service is determined to be needed to be accessed by the first service on behalf of the user. The user authentication token is converted into a proxy token that is not convertible back to the user authentication token. The proxy token is forwarded from the first service to the second service to enable access to the second service. A response is received by the first service from the second service due to the user having been authenticated based on the proxy token.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an authentication system in which a first service accesses a second service on behalf of a user by converting an authentication token of the user into a proxy token that may be forwarded to the second service, according to an example embodiment.

FIG. 2 shows a flowchart providing a process for enabling a first service to access a second service on behalf of a user by converting an authentication token of the user into a proxy token, according to an example embodiment.

FIG. 3 shows a block diagram of an identity provider configured to generate a user authentication token, according to an example embodiment.

FIG. 4 shows a flowchart providing a process for generating an authentication token for a user, according to an example embodiment.

FIG. 5 shows a block diagram of a first server configured to authenticate a user according to a user authentication token, and to convert the authentication token of the user into a proxy token to access a second service, according to an example embodiment.

FIG. 6 shows a flowchart providing a process for authenticating a user to access a first service, and at the first service, converting an authentication token of the user into a proxy token that may be forwarded to access a second service, according to an example embodiment.

FIG. 7 shows a flowchart providing a process for converting an authentication token of the user into a proxy token that may be forwarded to access a second service, according to an example embodiment.

FIG. 8 shows a block diagram of a proxy token generator, according to an example embodiment.

FIG. 9 shows a flowchart providing a process for obtaining and using a server authentication token to authenticate the first service at the second service, according to an example embodiment.

FIG. 10 shows a block diagram of an exemplary user device in which embodiments may be implemented.

FIG. 11 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments for Providing VPN Service to Multiple Tenants Via a Same IP Address

An authentication server or service provides a network service that applications use to authenticate the credentials of users. For instance, an authentication server may authenticate the account names and passwords of users. In one common scenario in an authentication system, a first authenticated service A (e.g., a web site or a first tier web application programming interface (API)) may have to act on behalf of a user to access a second authenticated service B (e.g., a second tier web API). An example of this is an email provider that provides web mail (a first authenticated service), and that also allows a user to manage their address book or calendar that is managed by a second authenticated service.

In a token based authentication system, a client obtains an authentication token from an identity provider (IdP). The user provides authentication credentials, and this token is submitted to service A (relying party (RP) of the IdP) to access the resources of service A. This token is typically scoped only to service A (or specific resources of service A), and allows service A to authenticate the user. If service A needs to request data from service B for the user, further authentication has to be performed, and many techniques for such further authentication exist, and such existing techniques have deficiencies:

For example, server-to-server authentication may be used. According to this technique, service B trusts service A to act on behalf of the user. A problem with this is that service B has to fully trust service A with all of its users′resources. Even if a user is not authenticated to service A, service A can still obtain the user's data in service B.

Token forwarding is another technique for authentication between services. According to token forwarding, service A simply forwards the authentication token of the user (scoped to either just service A, or both services A and B) to service B, so that service B will provide its services for the user. This solution allows service B to turn around and access service A on behalf of the user, which typically is not intended.

Delegation tokens are another technique. According to this technique, service A requests a first token to authenticate the user for itself, as well as a second (delegation) token that allows service B to authenticate the user. This means that multiple tokens are needed (one for each service), leading to more communications having to be performed. This means that in some scenarios (for example if service A is a web API) the client has to know all the different services that service A may have to interact with on behalf of the user.

Token exchange is still another technique. To address issues with multiple delegation tokens, a token exchange service can be used. A token exchange service may be operated by the IdP, allowing services to exchange their authentication token for authentication tokens scoped for other services. According to this technique, service A authenticates the user using the authentication token, and then exchanges this authentication token for another authentication token scoped for service B. A downside of this techniques is reduced performance and scalability. For the IdPs that exchange tokens, this solution essentially at least doubles the number of requests (one for the client to request the original authentication token, and one for the service to exchange the token). Additionally every token exchange request is a remote request for the service.

Embodiments enable a first tier web service (e.g., service A) to access a second tier web service B on behalf of a user, by converting its authentication token into a different form which can be forwarded to service B. Furthermore, the forwarded token (“proxy token”) cannot be used by service B in any way to access service's A resources. Such embodiments are applicable to token based authentication system that uses public-key cryptography, as well as being adaptable to other authentication systems.

In an embodiment, the first service (service A) can generate the proxy token without having to make any remote calls (for example to a token exchange service).

In an embodiment, a proxy token is cryptographically protected from being able to be reverted to its original form even by a malicious service B.

In an embodiment, a proxy token technique can be combined with a server-to-server authentication solution, to enable multi-hop scenarios (e.g. service A calling service B, which calls a service C, etc.).

Embodiments address and solve deficiencies of the commonly used solutions described above. For example, embodiments do not rely on a full trust relationship as in server-to-server authentication. Service B only trusts service A with the resources of authenticated users. Embodiments do not require bidirectional trust as do forwarded tokens. Service A does not have to trust service B with its resources. In some embodiments, a single token for the identity of the user is used. Unlike delegation token techniques, a client does not have to be aware of service A calling service B, for example. Still further, because token conversion does not include a remote request to the IdP for a token exchange, embodiments are much more scalable for the IdP, and more performant for the services.

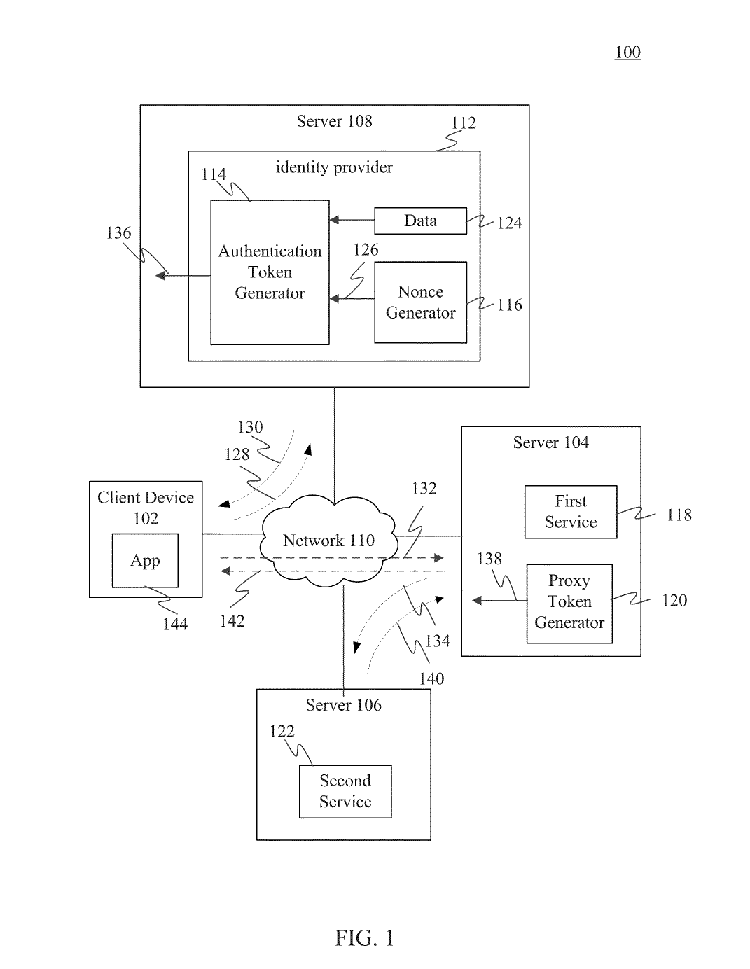

Embodiments may be implemented in various environments. For instance, FIG. 1 shows a block diagram of an authentication system 100 in which a first service 118 accesses a second service 122 on behalf of a user by converting an authentication token of the user into a proxy token that may be forwarded to second service 122, according to an example embodiment. As shown in FIG. 1, authentication system 100 includes a client device 102, a first server 104, a second server 106, and an identity provider server 108. A network 110 communicatively couples client device 102, first server 104, second server 106, and identity provider server 108. Client device 102 includes an application (“app”) 144. First server 104 includes first service 118 and a proxy token generator 120. Second server 106 includes second service 122. Identity provider service 108 includes an identity provider 112, which includes an authentication token generator 114 and a nonce generator 116. Authentication system 100 is further described as follows.

Client device 102 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), a wearable computing device (e.g., a smart watch, a head-mounted device including smart glasses such as Google® Glass™, etc.), or other type of mobile device (e.g., an automobile), or a stationary computing device such as a desktop computer or PC (personal computer). Still further, client device 102 may be a portable media player, a stationary or handheld gaming console, a personal navigation assistant, a camera, or other type of stationary or mobile device. Although a single client device is shown in FIG. 1, in other embodiments, other numbers of client devices may be present in system 100, including tens, hundreds, thousands, and millions of client devices.

Servers 104, 106, and 108 may each be formed of one or more computing devices that enable communications between devices and/or that are capable of serving information and/or providing other services. Servers 104, 106, and 108 may each include any number of individual server devices, including tens, hundreds, and thousands of servers.

Each of client device 102, server 104, server 106, and server 108 may include at least one network interface that enables communications over network 110. Such a network interface may be one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Examples of network 110 include a local area network (LAN), a wide area network (WAN), a personal area network (PAN), and/or a combination of communication networks, such as the Internet.

Client device 102 includes app 144, which executes therein. App 144 is a computer program that executes in hardware (e.g., one or more processors) of client device 102, and may be configured to perform any number of functions. A user may interact with client device 102 to interact with app 144. App 144 may access first service 118 on behalf of the user so that first service 118 can perform one or more services for the user and app 144. For example, app 144 may be a mail application (e.g., Microsoft® Outlook®, Google® Gmail™, Apple® Mail, etc.) that requests mail to be downloaded from first service 118, which may be the actual mail service. In another example, app 144 may be a web browser (e.g., Internet Explorer® developed by Microsoft Corp., Mozilla Firefox® developed by Mozilla Corp., Safari® developed by Apple Inc., Google® Chrome, etc.) that requests web objects (e.g., web pages, etc.) to be downloaded from first service 118, which may be a web server. Alternatively, first service 118 may be any other type of application that may request one or more services for a user and/or application.

In order to be able to access first service 118, the user may need to provide authentication information to server 104. Identity provider 112 at server 108 may be used to generate the authentication information for the user to access first service 118. As shown in FIG. 1, client device 102 may transmit an authentication token request 128 that is transmitted through network 110 to server 108. Identity provider 112 at server 108 receives authentication token request 128, and in response, generates a user authentication token 136 for the user.

For example, in the embodiment shown in FIG. 1, nonce generator 116 may be present to generate a nonce 126. Nonce 126 is a pseudo-random number (e.g., a cryptographically secure pseudo-random number) generated specifically for user authentication token 136, and thus is not used again in subsequent authentication tokens.

Nonce 126 and data 124 are received by authentication token generator 114 to be used to generate user authentication token 136. Data 124 includes one or more data elements, such as one or more of: one or more claims about the user, an identifier for identity provider 112 (the source of token 136), an identifier for first service 118 (the audience of token 136), an expiration time of token 136 (or an issue time of token 136, or token 136 could be non-expiring), and/or further data. Examples of claims about the user include an identifier for the user (e.g., a login name, etc.), a first and/or last name of the user, etc.

Authentication token generator 114 may generate user authentication token 136 based on data 124 and nonce 126 in numerous ways according to embodiments. For instance, authentication token generator 114 may perform one or more hashes of data 124, of nonce 126, and/or of a combination of nonce 126. Furthermore, authentication token generator 114 may generate a digital signature according to a digital signature algorithm performed on one or more of data 124, nonce 126, and/or any hash(es) thereof. Authentication token generator 114 may combine the digital signature with one or both of data 124 and nonce 126, and/or any hashes thereof, such as by appending them together, or combining them in another manner, to generate user authentication token 136. For instance, in one embodiment, user authentication token 136 may have the following form of:
data 124∥nonce 126∥Sig(Digest_2(Digest_1(nonce 126)∥data 124))K_IdP
   where:
∥=a symbol for an append function;
K_IdP=an asymmetric key pair of the identity provider 112 (IdP);
Sig=an asymmetric signature algorithm using the private key of asymmetric key pair K_IdP;
Digest_1=a cryptographic hash algorithm over nonce 126; and
Digest_2=a cryptographic hash algorithm over Digest_1 (nonce 126).
   Accordingly, in this example, user authentication token 136 includes data 124 appended to nonce 126, which is further appended to a digital signature of a second hash of a first hash appended to data 124. The first hash is hash of nonce 126, and the second hash is a hash of the hash of nonce 126 appended to data 124. In this example, any relying party, such as first service 118 in this example, has previously setup a trust relationship with the public key of K_IdP in a known manner. Note that in this example, Digest_1 and Digest_2 may be the same or different hash algorithms.

Thus, this example of user authentication token 136 is an embodiment of a convertible token. This example of user authentication token 136 may be used to authenticate the user for first service 118. Furthermore, first service 118 may convert this example of user authentication token 136 to a proxy token form that may be forwarded to second service 122, to have second service 122 perform a service on behalf of a user. However, second service 122 cannot convert or otherwise use this example of user authentication token 136 to gain access to server 104, first service 118, or any other server or service on behalf of the user. In this manner, this example of user authentication token 136 provides greater security relative to the conventional authentication techniques described above.

Accordingly, authentication token generator 114 generates user authentication token 136 as described above. As shown in FIG. 1, server 108 transmits an authentication token response 130 that is transmitted through network 110 to client device 102. Authentication token response 130 includes user authentication token 136. As a result, user authentication token 136 can be provided to server 104 to allow app 144 to access first service 118 on behalf of the user.

As shown in FIG. 1, client device 102 may transmit an authentication request 132 that is transmitted through network 110 to server 104. Authentication request 132 includes user authentication token 136. Server 104 may authenticate the user based on the received user authentication token 136, and therefore app 144 may be enabled to interact with first service 118 on behalf of the user.

During operation, first service 118 may determine that second service 122 needs to be accessed to perform a subsequent service on behalf of app 144 and the user. For instance, in the example where first service 118 is a mail server, second service 122 may be a calendar server, and app 144 may provide mail to the user, as well as the calendar of the user. As such, while first service 118 is accessed to provide mail to app 144 to display to the user, second service 122 may be accessed to provide the calendar maintained by second service 122 for the user.

Accordingly, first service 118 may request that proxy token generator 120 generate a converted version of user authentication token 136. The converted version of user authentication token 136, referred to as a proxy token 138, may be used to gain authorization for access to second service 122 by first service 118 on behalf of the user. However, proxy token 138 is configured such that second service 122 cannot use proxy token 138 to gain access to first service 118 or server 104 on behalf of the user. For instance, with regard to the above example of user authentication token 136, proxy token 138 may be generated by proxy token generator 120 to have the following form of:
data 124∥Digest_1(nonce 126)∥Sig(Digest_2(Digest_1(nonce 126)∥data 124))K_IdP
   In this example, second service 122 is not capable of reversing Digest_1, and therefore is prevented from generating an authorization token that would be accepted by first service 118. In this manner, greater security is provided by proxy token 138 relative to conventional user authentication tokens.

Accordingly, as shown in FIG. 1, server 104 may transmit an authentication request 134 that is transmitted through network 110 to server 106. Authentication request 134 includes proxy token 138, and may additionally include information about the user (e.g., login credentials, etc.). Server 106 may authenticate the user based on the received proxy token 138, and therefore first service 118 may be enabled to interact with second service 122 on behalf of the user. For example, as shown in FIG. 1, second service 122 may transmit one or more second service resources 140 from server 106 to server 104. Second service resource(s) 140 includes one or more resources (e.g., calendar entries) that were requested on behalf of app 144 and the user in authentication request 134 and/or in other communications (not shown in FIG. 1). In turn, first service 118 may transmit one or more resources 142 from server 104 to client device 102. Resource(s) 142 includes one or more resources (e.g., mail messages) that were requested on behalf of app 144 and the user in authentication request 132 and/or in other communications (not shown in FIG. 1), and may include one or more resources (e.g., calendar entries) received from second service 122 in second service resource(s).

In this manner, a service-to-service user authorization is enabled in a secure and communication efficient manner. A first service may convert a user authentication token to a proxy token form that may be forwarded to a second service, on behalf of a user. However, the second service is not enabled to generate a user authentication token based on the proxy token that would be acceptable by the first service on behalf of the user, thereby providing additional security for the user and other users relative to server-to-server and token forwarding techniques. Furthermore, fewer communications are made to enable the service-to-service authorization relative to delegation token and token exchange techniques.

The following subsections describe further exemplary embodiments for service-to-service authentication on behalf of user, such as is implemented in authentication system 100 of FIG. 1. For instance, the following subsection describes example embodiments for an identity provider that generates a user authentication token, which is followed by a subsection that describes example embodiments for service-to-service authentication using a proxy token generated from such a user authentication token.

A. Example Embodiments for an Identity Provider

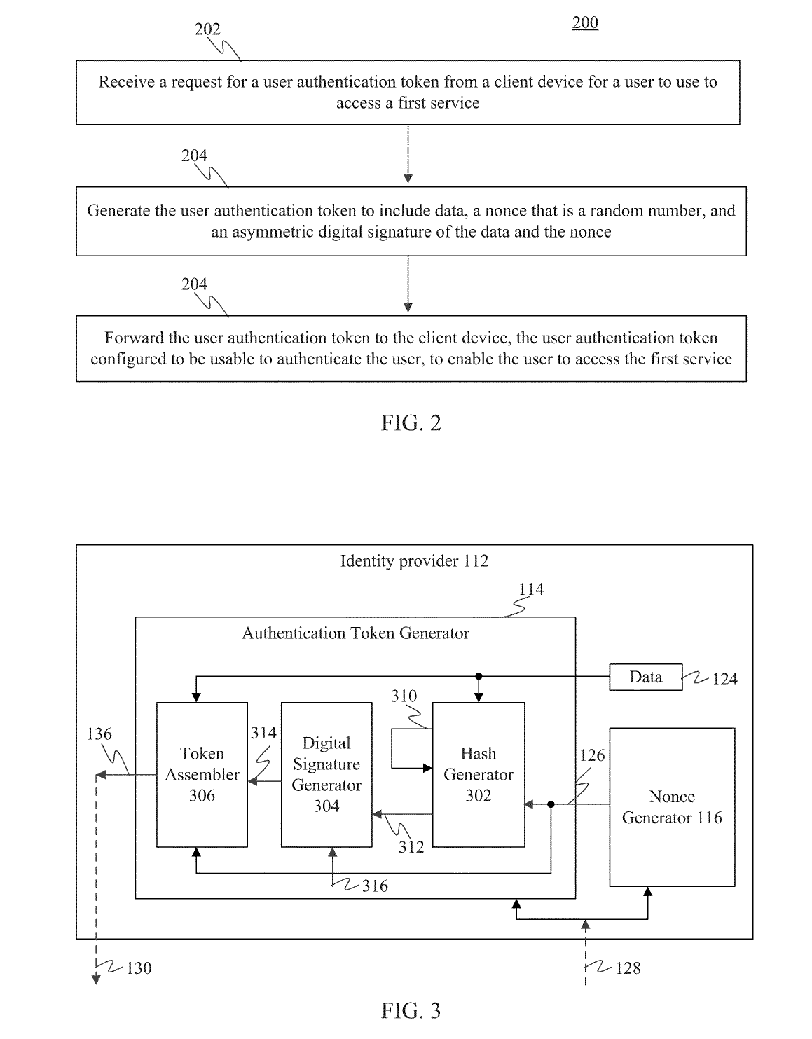

In embodiments, identity provider 112 of FIG. 1 may be configured in various ways to generate user authentication token 136, and may operate in various ways. For instance, FIG. 2 shows a flowchart 200 providing a process for enabling a first service to access a second service on behalf of a user by converting an authentication token of the user into a proxy token, according to an example embodiment. Identity provider 112 may operate according to flowchart 200 in embodiments. For illustrative purposes, flowchart 200 is described below with respect to FIG. 3. FIG. 3 shows a block diagram of identity provider 112 of FIG. 1, according to an example embodiment. As shown in FIG. 3, identity provider 112 includes authentication token generator 114 and nonce generator 116. Furthermore, authentication token generator 114 includes a hash generator 302, a digital signature generator 304, and a token assembler 306. Further structural and operational embodiments will be apparent to persons skilled in the relevant art(s) based on the following description of FIGS. 2 and 3.

Flowchart 200 of FIG. 2 begins with step 202. In step 202, a request for a user authentication token is received from a client device for a user to use to access a first service. For example, as shown in FIG. 3, identity provider 112 receives authentication token request 128 (e.g., from client device 102 shown in FIG. 1). Authentication token request 128 is a request for a token to be used to enable a user of the client device to access a service, such as first service 118 in FIG. 1. Authentication token request 128 may be transmitted and received as a signal of any type described herein or otherwise known. Authentication token request 128 may include information such as an identifier for the user (e.g., a user name or login name), a password or other credentials corresponding to the user identifier, an identifier for the service desired to be accessed, and identifier for the client device, and/or other information.

In step 204, the user authentication token is generated to include data, a nonce that is a random number, and an asymmetric digital signature of the data and the nonce. In an embodiment, authentication token request 128 causes identity provider 112 to generate user authentication token 136 for the user. In particular, authentication token generator 114 of identity provider 112 may generate user authentication token 136. In an embodiment, user authentication token 136 may be generated at least based on data 124 and nonce 126.

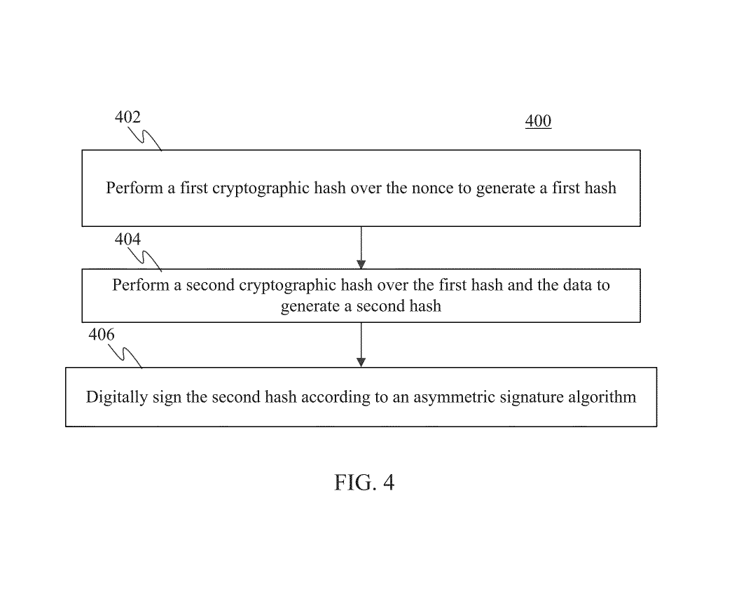

User authentication token 136 may be generated in various ways by authentication token generator 114, in embodiments. For instance, FIG. 4 shows a flowchart 400 providing a process for generating an authentication token for a user, according to an example embodiment. In an embodiment, authentication token generator 114 may operate according to flowchart 400. Flowchart 400 is described as follows.

Flowchart 400 begins with step 402. In step 402, a first cryptographic hash is performed over the nonce to generate a first hash. For example, as shown in FIG. 3, nonce generator 116 receives request 128 (or in indication thereof). In response, nonce generator 116 generates nonce 126. As described above, nonce 126 is a random number generated specifically for user authentication token 136, and thus is not used again in subsequent authentication tokens. Nonce generator 116 may generate nonce 126 according to any suitable random number generation technique as would be known to persons skilled in the relevant art(s), and may generate nonce 126 to have any bit length considered to be cryptographically secure (e.g., 128 bits, 196 bits, 256 bits, etc.). For instance, in an embodiment, nonce generator 116 may generate nonce 126 to be a cryptographically random number. In such an embodiment, nonce generator 116 may be a cryptographically secure pseudo-random number generator (CSPRNG), or a cryptographic pseudo-random number generator (CPRNG), which are pseudo-random number generators. Various techniques may be used to generate a cryptographically random number for nonce 126, such as hashes, the Blum Blum Shub algorithm, the Blum-Micali algorithm, the Yarrow algorithm, the Fortuna algorithm, etc.

Furthermore, as shown in FIG. 3, authentication token generator 114 receives request 128 (or in indication thereof). In response, authentication token generator 114 generates user authentication token 136 based on data 124 and nonce 126, and a generated digital signature. In particular, in the embodiment of FIG. 3, hash generator 302 receives nonce 126. Hash generator 302 generates a first hash 310 based on nonce 126. For instance, a cryptographic hash function or algorithm implemented by hash generator 302, such as a SHA-2 (secure hash algorithm) hash function (e.g., SHA256, etc.) or other type of cryptographic hash function, may receive nonce 126 as input, and may hash nonce 126 to generate first hash 310.

Referring back to flowchart 400 in FIG. 4, in step 404, a second cryptographic hash is performed over the first hash and the data to generate a second hash. As shown in the example of FIG. 3, hash generator 302 receives first hash 310 and data 124 as input. Hash generator 302 may combine first hash 310 and data 124, such as by appending the bits of data 124 to the bits of first hash 310, and may generate a second hash 312 based on the combination of first hash 310 and data 124. For instance, the same hashing algorithm implemented by hash generator 302 to generate first hash 310 may be used, or an alternative hash function may be used, that receives the combination of first hash 310 and data 124 as input, and may hash the combination to generate second hash 312.

In step 406, the second hash is digitally signed according to an asymmetric signature algorithm. As shown in FIG. 3, digital signature generator 304 receives second hash 312 and a private key 316. Private key 316 is a private key of an asymmetric key pair K_IdP of identity provider 112. A service, such as first service 118, that accepts tokens generated by identity provider 112 has a trust relationship with the public key of asymmetric key pair K_IdP of identity provider 112. As such, digital signature generator 304 is configured to generate a digital signature 314 based on second hash 312 and private key 316 using a digital signature algorithm. In an embodiment, the signature algorithm may be an asymmetric signature algorithm (e.g., RSA (Rivest Shamir Adleman), etc.). For instance, digital signature generator 304 may implement the RSA public key-private key signature algorithm, or other digital signature algorithm, to generate digital signature 314.

Accordingly, as shown in FIG. 3, token assembler 306 receives data 124, nonce 126, and digital signature 314. As described above, data 124 may include one or more data elements, such as one or more of: one or more claims about the user, an identifier for identity provider 112 (the source of token 136), an identifier for first service 118 (the audience of token 136), an expiration time of token 136, and/or further data. Examples of claims about the user include an identifier for the user (e.g., a login name, etc.), a first and/or last name of the user, other identifying information regarding the user and/or client device 102, etc.

Token assembler 306 is configured to combine together data 124, nonce 126, and digital signature 314 to generate user authentication token 136. For example, in an embodiment, token assembler 306 may combine data 124, nonce 126, and digital signature 314 by appending their respective bit strings directly together in sequence, by appending their respective bit strings together with additional separation bits that separate them, by including additional data, and/or by combining them in any other manner. Data 124, nonce 126, and digital signature 314 may be included in user authentication token 136 in any order, including the following order:
Data 124∥nonce 126∥digital signature 314

Referring back to flowchart 200 in FIG. 2, in step 206, the user authentication token is forwarded to the client device, the user authentication token configured to be usable to authenticate the user, to enable the user to access the first service. For example, as shown in FIG. 3, user authentication token 136 may be transmitted from identity provider 112, as well as from server 108 (FIG. 1) in authentication token response 130. As shown in FIG. 1, client device 102 receives authentication token response 130 through network 110. Client device 102 may forward user authentication token 136 (extracted from authentication token response 130) through network 110 in authentication request 132 to server 104. Server 104 may authenticate the user via user authentication token 136 (extracted from authentication request 132), and as a result, first service 118 may be accessed by app 144 (at client device 102) on behalf of the user.

B. Example Embodiments for Service-to-Service Authentication Using a Proxy Token

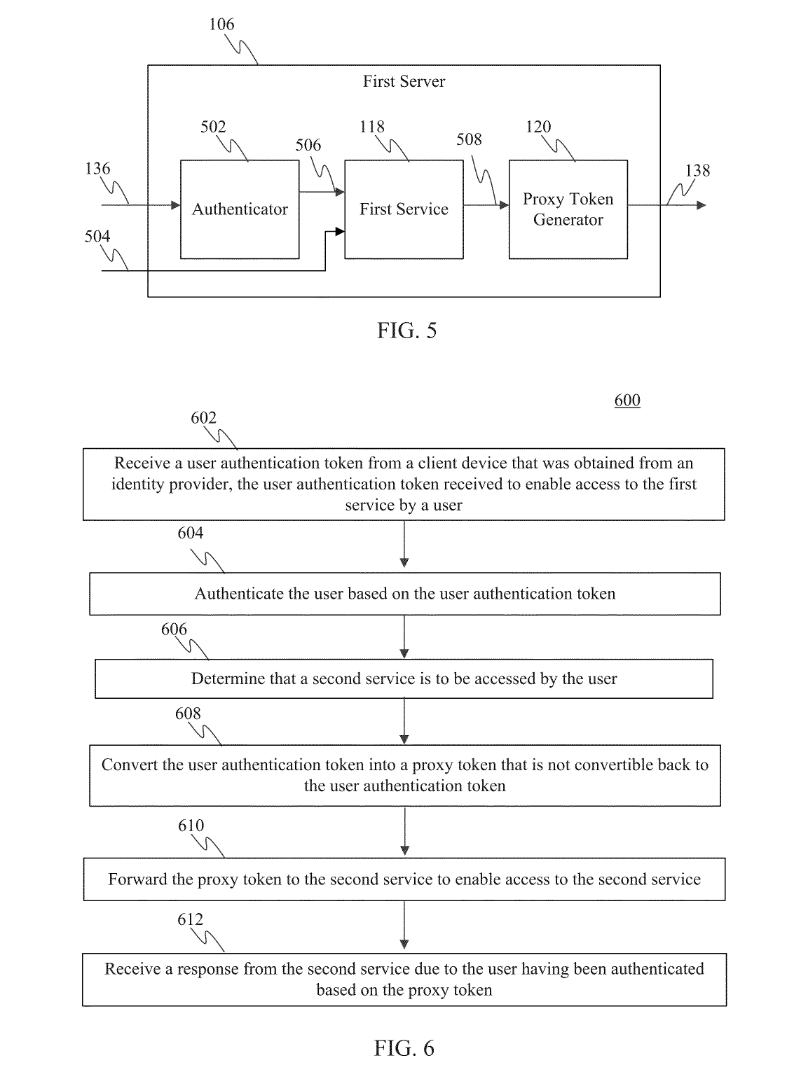

In embodiments, first server 106 of FIG. 1 may be configured in various ways to authenticate a user based on a user authentication token, and to generate a proxy token from the user authentication token that is used to access a second service. For example, FIG. 5 shows a block diagram of first server 106 configured to authenticate a user according to a user authentication token, and to convert the authentication token of the user into a proxy token to access a second service, according to an example embodiment. As shown in FIG. 5, first server 106 includes an authenticator 502, first service 118, and proxy token generator 120.

First server 106 may operate in various ways, including in the ways described above. For instance, FIG. 6 shows a flowchart 600 providing a process for authenticating a user to access a first service, and at the first service, converting an authentication token of the user into a proxy token that may be forwarded to access a second service, according to an example embodiment. In an embodiment, first server 106 may operate according to flowchart 600. For illustrative purposes, flowchart 600 is described below with respect to FIGS. 1 and 5. Further structural and operational embodiments will be apparent to persons skilled in the relevant art(s) based on the following description.

Flowchart 600 of FIG. 6 begins with step 602. In step 602, a user authentication token is received from a client device that was obtained from an identity provider, the user authentication token received to enable access to the first service by a user. For example, as described above with respect to FIGS. 1-4, a user authentication token may be requested by client device 102 from identity provider 112 to enable access to first service 118, and in response, identity provider 112 may generate and provide user authentication token 136 to client device 102. Server 104 may receive user authentication token 136 from client device 102 (e.g., in authentication request 132) to enable the user to access first service 118 through app 144.

In step 604, the user is authenticated based on the user authentication token. In an embodiment, authenticator 502 of FIG. 5 may receive user authentication token 136, and may be configured to authenticate the user based thereon. To authenticate the user, authenticator 502 may verify digital signature 314 included in user authentication token 136. To verify digital signature 314, authenticator 502 may separately calculate a hash based on data 124 and nonce 126 received in user authentication token 136, and the public key of the asymmetric key pair, and may compare the calculated hash to the hash (second hash 312 of FIG. 3) received in digital signature 314 of authentication token 136. If the two hashes match, digital signature 314 is verified, and the user may be considered to be authenticated. The user may thereby be enabled to access first service 118. If the separately calculated hash does not match the hash in digital signature 314, the user may be considered to not be authenticated, and may not access first service 118.

For instance, when authenticator 502 receives user authentication token 136 as shown below:
data 124∥nonce 126∥digital signature 314
   where:
digital signature 314=Sig(Digest_2(Digest_1(nonce 126)∥data 124))K_IdP
   Authenticator 502 may recalculate second hash 312 (FIG. 3) according to flowchart 400 (FIG. 4), by separately calculating first hash 310 (step 402) based on nonce 126, and calculating second hash 312 (step 404 based on nonce 126 and data 124. However, in a public key-private key embodiment, rather than using the private key (as in identity provider 112), authenticator 502 may use the trusted public key that is associated with the private key used by identity provider 112 to generate second hash 312. Whether or not second hash 312 generated using the public key by authenticator 502 matches the received hash in digital signature 314 (generated using the private key) determines whether the user is authenticated or not.

In step 606, it is determined that a second service is to be accessed by the user. In an embodiment, assuming that the user is authenticated in step 604, app 144 may access first service 118 on behalf of the user. First service 118 may transmit requested resources to app 144 (e.g., test or email messages, etc.) and/or provide other services for app 144. Furthermore, first service 118 may determine that second service 122 is to be accessed for the user for further services not available at first service 118 (e.g., calendar entries, etc.).

In step 608, the user authentication token is converted into a proxy token that is not convertible back to the user authentication token. In an embodiment, when it is determined that second service 122 is to be accessed on behalf of the user, proxy token 138 may be generated from user authentication token 136. Proxy token 138 may be used to authenticate the user at second service 122 to enable first service 118 to access second service 122 on behalf of the user.

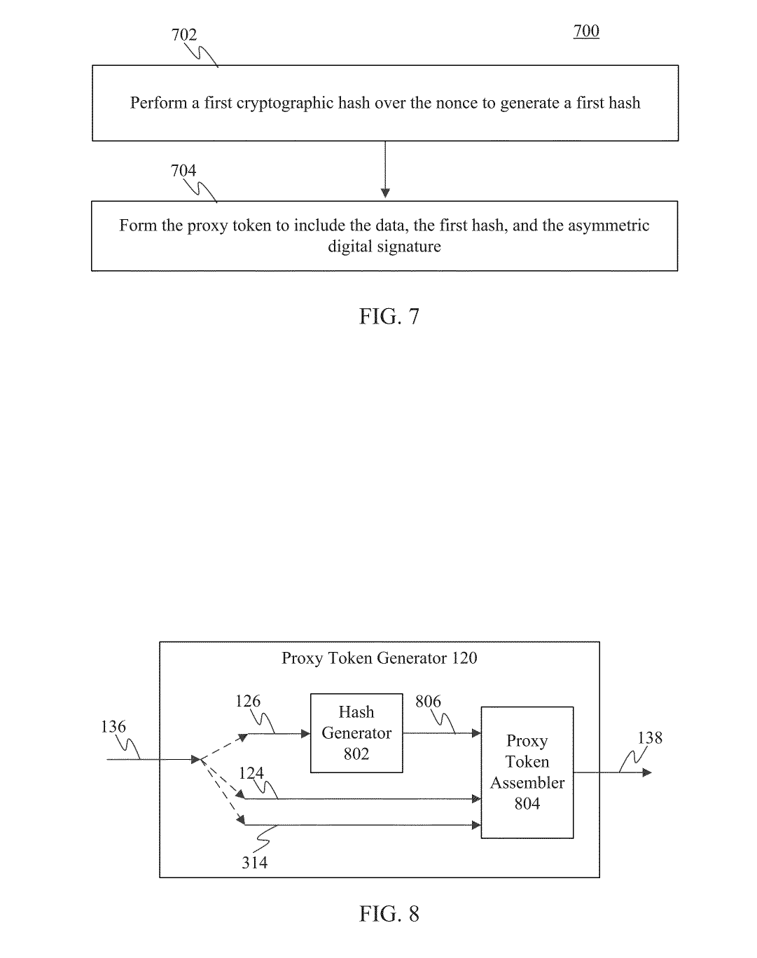

Proxy token generator 120 may be configured in various ways, and may operate in various ways, to generate proxy token 138. For instance, FIG. 7 shows a flowchart 700 providing a process for converting an authentication token of the user into a proxy token that may be forwarded to access a second service, according to an example embodiment. Proxy token generator 120 may operate according to flowchart 700 in an embodiment. For illustrative purposes, flowchart 700 is described below with respect to FIG. 8. FIG. 8 shows a block diagram of proxy token generator 120, according to an example embodiment. As shown in FIG. 8, proxy token generator 120 includes a hash generator 802 and a proxy token assembler 804. Further structural and operational embodiments will be apparent to persons skilled in the relevant art(s) based on the following description of FIGS. 7 and 8.

Flowchart 700 of FIG. 7 begins with step 702. In step 702, a first cryptographic hash is performed over the nonce to generate a first hash. As shown in FIG. 8, proxy token generator 120 may receive user authentication token 136, which is composed of data 124, nonce 126, and digital signature 314. Hash generator 802 receives nonce 126. Hash generator 802 generates a first hash 802 based on nonce 126. For instance, a hashing algorithm implemented by hash generator 802, such as a SHA-2 (secure hash algorithm) hash function (e.g., SHA256, etc.) or other type of cryptographic hash function, may receive nonce 126 as input, and may hash nonce 126 to generate first hash 806. First hash 806 may be generated similarly to first hash 310 (FIG. 3) described above, and in an embodiment has the same value as first hash 310.

In step 704, the proxy token is formed to include the data, the first hash, and the asymmetric digital signature. As shown in FIG. 8, proxy token assembler 804 receives data 124, digital signature 314, and first hash 806. Proxy token assembler 804 is configured to combine together data 124, digital signature 314, and first hash 806 to generate proxy token 138. For example, in an embodiment, proxy token assembler 804 may combine data 124, digital signature 314, and first hash 806 by appending their respective bit strings directly together in sequence, by appending their respective bit strings together with additional separation bits that separate them, by including additional data, and/or by combining them in any other manner. Data 124, digital signature 314, and first hash 806 may be included in user authentication token 136 in any order, including the following order:
Data 124∥first hash 806∥digital signature 314

Referring back to FIG. 6, in step 610, the proxy token is forwarded to the second service to enable access to the second service. In an embodiment, when converting user authentication token 136, the claims are not modified, and user authentication token 136 can now be forwarded by first service 118 to second service 122 as described above with respect to FIG. 1. For example, as shown in FIG. 1, server 104 may transmit an authentication request 134 that is transmitted through network 110 to server 106. Authentication request 134 includes proxy token 138. Server 104 or second service 122 can still validate digital signature 314 included in proxy token 138 because nonce 126 is available in hashed form in first hash 806. For example, an authenticator of server 104 (similar to authenticator 502 of FIG. 5) may recalculate digital signature 314 by executing the digital signature algorithm over first hash 806 using the trusted public key that is associated with the private key used by identity provider 112 to generate digital signature 314. Whether or not the recalculated digital signature generated using the public key matches the digital signature 314 received in proxy token 138 determines whether the user is authenticated or not at second service 122.

However, server 106 and second service 122 cannot reverse the hash used to generate first hash 806. As such, server 106 and second service 122 cannot generate an authorization token that server 104 or first service 118 would accept (e.g., cannot replicate nonce 126). Accordingly, enhanced security is provided by using proxy token 138, because server 106 and second service 122 are prevented from using or manipulating proxy token 138 in any manner to gain access to user information or services at server 104.

In step 612, a response is received from the second service due to the user having been authenticated based on the proxy token. When proxy token 138 is successfully authenticated at second service 122, first service 118 can access second service 122 on behalf of app 144 and the user.

For example, as described above and shown in FIG. 1, second service 122 may transmit one or more second service resources 140 from server 106 to server 104. Second service resource(s) 140 includes one or more resources that were requested on behalf of app 144 and the user in authentication request 134 and/or in other communications. In turn, first service 118 may transmit one or more resources 142 from server 104 to client device 102. Resource(s) 142 includes one or more resources that were requested on behalf of app 144 and the user in authentication request 132 and/or in other communications (not shown in FIG. 1), and may include one or more resources received from second service 122 in second service resource(s) 140.

C. Example Advantages and Further Embodiments

According to embodiments, a service-to-service user authorization is enabled in a secure and communication efficient manner. A first service may convert a user authentication token to a proxy token form that may be forwarded to a second service, on behalf of a user. However, the second service is not enabled to generate a user authentication token based on the proxy token that would be acceptable by the first service on behalf of the user. In an embodiment, this is because the second service cannot regenerate the digital signature generated by the identity provider, which in turn is because the second service is not provided with information needed to generate that digital signature (e.g., a nonce value). As a result, additional security is provided for the user and other users relative to conventional techniques, such as server-to-server and token forwarding techniques. Furthermore, fewer communications are made to enable the service-to-service authorization relative to delegation token and token exchange techniques.

User authentication token 136 in the above embodiments is different from conventional authentication tokens due to the inclusion of additional information (e.g., nonce 126). An example conventional token is shown below:
data∥Sig(Digest_1(data))K_IdP
   In this example, the conventional user authentication token includes data appended to a digital signature of the hashed data. No nonce or other additional data is present that is unique to the conventional user authentication token. Accordingly, the conventional user authentication token is susceptible to being used surreptitiously, because a server or service that receives such a token may be able to generate a token based on the received data that the first service may accept.

In some embodiments described above, a single token—proxy token 138—is provided from first service 118 to second service 122 to enable authentication. In another embodiment, in addition to the proxy token, which enables authentication for the user, a second token may be provided—a server authentication token—that enables authorization for the first server, and thereby the first service, at the second service. Alternatively, other techniques may be used for server-to-server authentication, such as IP ACLs (Internet Protocol access control lists), client certificates, etc.

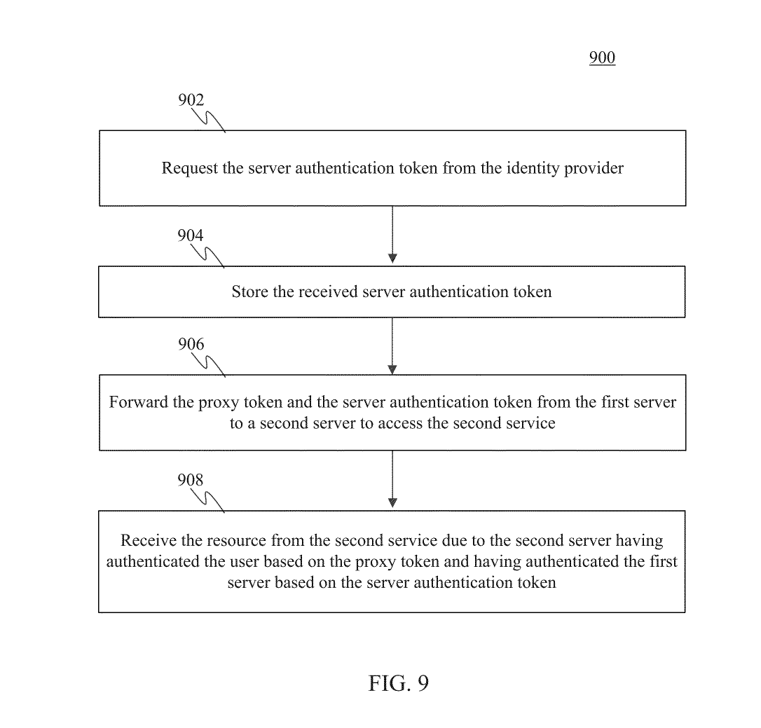

For instance, FIG. 9 shows a flowchart 900 providing a process for obtaining and using a server authentication token to authenticate the first service at the second service, according to an example embodiment. In an embodiment, flowchart 900 may be performed by server 104 and first service 118, and may be performed in combination with embodiments described above (e.g., with flowchart 600). Flowchart 900 is described as follows. Further structural and operational embodiments will be apparent to persons skilled in the relevant art(s) based on the following description. For example, although server authentication tokens are described in flowchart 900, other techniques for server-to-server authentication may alternatively be used, such as the techniques described herein (e.g., IP ACLs, etc.) or other techniques that would be known to persons skilled in the relevant art(s). Server authentication token, client certificates, and other objects that may be used for server-to-server authentication are referred to herein collectively as “server authentication objects.” In another embodiment, an IP access control list may be used by a target service to determine whether to enable access to a particular requesting server. Access to the requesting server may be granted based on whether the IP address of the requesting server is in the access control list.

Flowchart 900 begins with step 902. In step 902, the server authentication token is requested from the identity provider. In an embodiment, server 104 of FIG. 1 may transmit an authentication token request to identity provider 112 at server 108 (or other identity provider). The authentication token is requested to enable server 104 to be authenticated by other servers and services, to enable access by server 104 to those other servers and services. Accordingly, identity provider 112 may generate a server authentication token for server 104, and may transmit the server authentication token to server 104 (e.g., through network 110).

The server authentication token may be generated by identity provider 112 in any manner. For instance, the server authentication token may include a digital signature (e.g., generated by digital signature generator 304 of FIG. 3) on data containing claims related to server 104, and may be generated based on a private key of an asymmetric key pair of identity provider 112. Thus, the server authentication token may include the data related to server 104 and the digital signature generated therefrom.

In step 904, the received server authentication token is stored. In an embodiment, server 104 receives the server authentication token, and stores the server authentication token for subsequent use. Server 104 may store the server authentication token in any suitable storage, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Note that steps 902 and 904 may be performed at any time prior to performance of steps 906 and 908, including hours, days, or even months prior to steps 906 and 908. The server authentication token may have an associated expiration time, after which it is invalid, and a new server authentication token is requested.

In step 906, the proxy token and the server authentication token are forwarded from the first server to a second server to access the second service. Note that step 906 can be performed during step 610 of flowchart 600 (FIG. 6). In such an embodiment, proxy token 138 and the server authentication token may be transmitted to server 106 in request 134. Server 106 and/or second service 122 have to authenticate both proxy token 138 and the server authentication token to enable first service 118 to access second service 122 on behalf of the user and app 144. The server authentication token may be authenticated in a similar manner as described for proxy token 138 (e.g., an authenticator of server 106 recalculating the digital signature based on the server-related data included in the server authentication token).

In step 908, the resource is received from the second service due to the second server having authenticated the user based on the proxy token and having authenticated the first server based on the server authentication token. Note that step 908 can be performed during step 612 of flowchart 600 (FIG. 6). In such an embodiment, when proxy token 138 and the server authentication token are successfully authenticated at second service 122, first service 118 can access second service 122 on behalf of app 144 and the user.

Accordingly, in an embodiment, server 104 requests the server authentication token from identity provider 112 using a private key whose public key has been previously registered with identity provider 112. Upon successful authentication, identity provider 112 sends the authentication token to server 104. This server authentication token signed by identity provider 112 contains the public key used for authentication, so a subsequent service (e.g., at server 106) can require that the authentication token can only be used if the request is signed with the private key as well (i.e., server 104 proofs possession of the key, hence the name proof-of-possession).

In further embodiments, a hash chain may be used on a nonce included in a user authentication token to allow the token to be converted multiple times. For instance, in an embodiment, a user authentication token generated by identity provider 112 for a user may have the following form:
data 124∥nonce 126∥second nonce∥third nonce∥digital signature 314
   where:
digital signature 314=Sig(Digest_4(Digest_1(1st nonce)∥Digest_2(2nd nonce)∥Digest_3(3rd nonce)∥data 124))K_IdP

Accordingly, in this example, the user authentication token is similar to embodiments described above, where a first nonce is present (nonce 126), and one or more additional nonces are included (e.g., second nonce and third nonce), with each nonce corresponding to a service. Client device 102 can receive this user authentication token, and can forward the user authentication token to be authenticated at first service 118 as described above. Furthermore, proxy token generator 120 may generate a proxy token from this user authentication token for second service 122 in a modified fashion, where the second and third nonces are included:
data∥Digest_1(nonce1)∥nonce2∥nonce3∥digital signature 314
   Second service 122 may receive this proxy token, and determine that a third service is to be accessed on behalf of the user. Accordingly, second service 122 may generate a next proxy token based on the contents of proxy token 138. For example, a proxy token generator 120 at second service 106 may generate the following next proxy token:
data∥Digest_1(nonce1)∥Digest_2(nonce2)∥nonce3∥digital signature 314
   Thus, in a similar manner as described above, this next proxy token may be transmitted to the third service by second service 122. The third service may authenticate second service 122 based on this next proxy token, so that second service 122 can access the third service on behalf of the user. However, the third service cannot use this next proxy token to access second service 122 (e.g., because second nonce is not known at the third service).

In an similar manner, the third nonce may by the third service to generate a third proxy token to access a fourth service on behalf of the user, and any number of further services may be accessed on behalf of the user, depending on the number of nonces included in the user authentication token generated by identity provider 112. Note that each service may additionally provide the server authentication token of its respective server when using a proxy token to access a next service on behalf of a user. It is noted that in such an embodiment, an earlier service may be enabled to impersonate a later service in the communication chain, and therefore it may be desired to use this technique for cascading nonces in conjunction with server-to-server authentication.

Embodiments may be combined with any server-to-server authentication technique.

### III. Example Mobile and Stationary Device Embodiments

Client device 102, servers 104, 106, and 108, identity provider 112, authentication token generator 114, nonce generator 116, first service 118, proxy token generator 120, second service 122, hash generator 302, digital signature generator 304, token assembler 306, authenticator 502, hash generator 802, proxy token assembler 804, flowchart 200, flowchart 400, flowchart 600, flowchart 700, and flowchart 900 may be implemented in hardware, or hardware combined with software and/or firmware. For example, identity provider 112, authentication token generator 114, nonce generator 116, first service 118, proxy token generator 120, second service 122, hash generator 302, digital signature generator 304, token assembler 306, authenticator 502, hash generator 802, proxy token assembler 804, flowchart 200, flowchart 400, flowchart 600, flowchart 700, and/or flowchart 900 may be implemented as computer program code/instructions configured to be executed in one or more processors and stored in a computer readable storage medium. Alternatively, client device 102, servers 104, 106, and 108, identity provider 112, authentication token generator 114, nonce generator 116, first service 118, proxy token generator 120, second service 122, hash generator 302, digital signature generator 304, token assembler 306, authenticator 502, hash generator 802, proxy token assembler 804, flowchart 200, flowchart 400, flowchart 600, flowchart 700, and/or flowchart 900 may be implemented as hardware logic/electrical circuitry.

For instance, in an embodiment, one or more, in any combination, of identity provider 112, authentication token generator 114, nonce generator 116, first service 118, proxy token generator 120, second service 122, hash generator 302, digital signature generator 304, token assembler 306, authenticator 502, hash generator 802, proxy token assembler 804, flowchart 200, flowchart 400, flowchart 600, flowchart 700, and/or flowchart 900 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

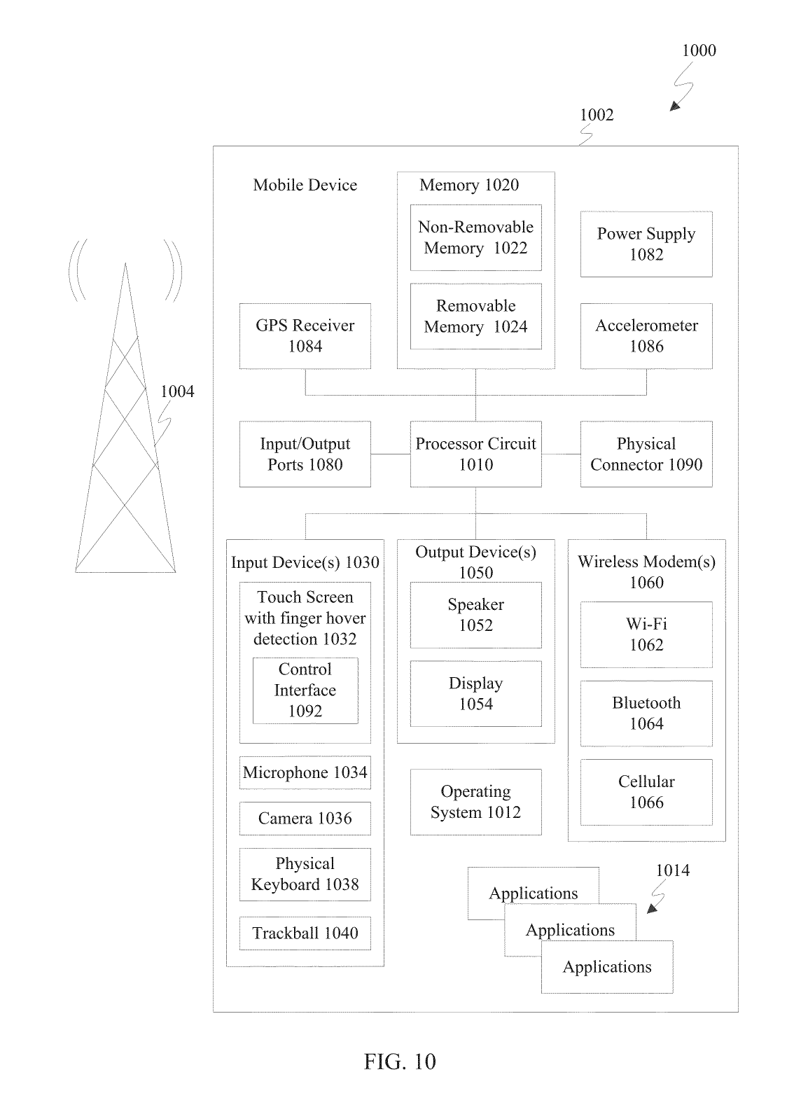

FIG. 10 shows a block diagram of an exemplary mobile device 1000 including a variety of optional hardware and software components, shown generally as components 1002. For instance, components 1002 of mobile device 1000 are examples of components that may be included in client device 102 (FIG. 1) in mobile device embodiments. Any number and combination of the features/elements of components 1002 may be included in a mobile device embodiment, as well as additional and/or alternative features/elements, as would be known to persons skilled in the relevant art(s). It is noted that any of components 1002 can communicate with any other of components 1002, although not all connections are shown, for ease of illustration. Mobile device 1000 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 1004, such as a cellular or satellite network, or with a local area or wide area network.

The illustrated mobile device 1000 can include a controller or processor referred to as processor circuit 1010 for performing such tasks as signal coding, image processing, data processing, input/output processing, power control, and/or other functions. Processor circuit 1010 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1010 may execute program code stored in a computer readable medium, such as program code of one or more applications 1014, operating system 1012, any program code stored in memory 1020, etc. Operating system 1012 can control the allocation and usage of the components 1002 and support for one or more application programs 1014 (a.k.a. applications, “apps”, etc.). Application programs 1014 can include common mobile computing applications (e.g., email applications, calendars, contact managers, web browsers, messaging applications) and any other computing applications (e.g., word processing applications, mapping applications, media player applications).

As illustrated, mobile device 1000 can include memory 1020. Memory 1020 can include non-removable memory 1022 and/or removable memory 1024. The non-removable memory 1022 can include RAM, ROM, flash memory, a hard disk, or other well-known memory storage technologies. The removable memory 1024 can include flash memory or a Subscriber Identity Module (SIM) card, which is well known in GSM communication systems, or other well-known memory storage technologies, such as “smart cards.” The memory 1020 can be used for storing data and/or code for running the operating system 1012 and the applications 1014. Example data can include web pages, text, images, sound files, video data, or other data sets to be sent to and/or received from one or more network servers or other devices via one or more wired or wireless networks. Memory 1020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 1020. These programs include operating system 1012, one or more application programs 1014, and other program modules and program data. Examples of such application programs or program modules may include, for example, computer program logic (e.g., computer program code or instructions) for implementing identity provider 112, authentication token generator 114, nonce generator 116, first service 118, proxy token generator 120, second service 122, hash generator 302, digital signature generator 304, token assembler 306, authenticator 502, hash generator 802, proxy token assembler 804, flowchart 200, flowchart 400, flowchart 600, flowchart 700, and/or flowchart 900 (including any suitable step of flowcharts 200, 400, 600, 700, 900), and/or further embodiments described herein.

Mobile device 1000 can support one or more input devices 1030, such as a touch screen 1032, microphone 1034, camera 1036, physical keyboard 1038 and/or trackball 1040 and one or more output devices 1050, such as a speaker 1052 and a display 1054. Touch screens, such as touch screen 1032, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 1032 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

The touch screen 1032 is shown to include a control interface 1092 for illustrative purposes. The control interface 1092 is configured to control content associated with a virtual element that is displayed on the touch screen 1032. In an example embodiment, the control interface 1092 is configured to control content that is provided by one or more of applications 1014. For instance, when a user of the mobile device 1000 utilizes an application, the control interface 1092 may be presented to the user on touch screen 1032 to enable the user to access controls that control such content. Presentation of the control interface 1092 may be based on (e.g., triggered by) detection of a motion within a designated distance from the touch screen 1032 or absence of such motion. Example embodiments for causing a control interface (e.g., control interface 1092) to be presented on a touch screen (e.g., touch screen 1032) based on a motion or absence thereof are described in greater detail below.

Other possible output devices (not shown) can include piezoelectric or other haptic output devices. Some devices can serve more than one input/output function. For example, touch screen 1032 and display 1054 can be combined in a single input/output device. The input devices 1030 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1012 or applications 1014 can comprise speech-recognition software as part of a voice control interface that allows a user to operate the device 1000 via voice commands. Further, device 1000 can comprise input devices and software that allows for user interaction via a user's spatial gestures, such as detecting and interpreting gestures to provide input to a gaming application.

Wireless modem(s) 1060 can be coupled to antenna(s) (not shown) and can support two-way communications between processor circuit 1010 and external devices, as is well understood in the art. The modem(s) 1060 are shown generically and can include a cellular modem 1066 for communicating with the mobile communication network 1004 and/or other radio-based modems (e.g., Bluetooth 1064 and/or Wi-Fi 1062). Cellular modem 1066 may be configured to enable phone calls (and optionally transmit data) according to any suitable communication standard or technology, such as GSM, 3G, 4G, 5G, etc. At least one of the wireless modem(s) 1060 is typically configured for communication with one or more cellular networks, such as a GSM network for data and voice communications within a single cellular network, between cellular networks, or between the mobile device and a public switched telephone network (PSTN).

Mobile device 1000 can further include at least one input/output port 1080, a power supply 1082, a satellite navigation system receiver 1084, such as a Global Positioning System (GPS) receiver, an accelerometer 1086, and/or a physical connector 1090, which can be a USB port, IEEE 1394 (FireWire) port, and/or RS-232 port. The illustrated components 1002 are not required or all-inclusive, as any components can be not present and other components can be additionally present as would be recognized by one skilled in the art.

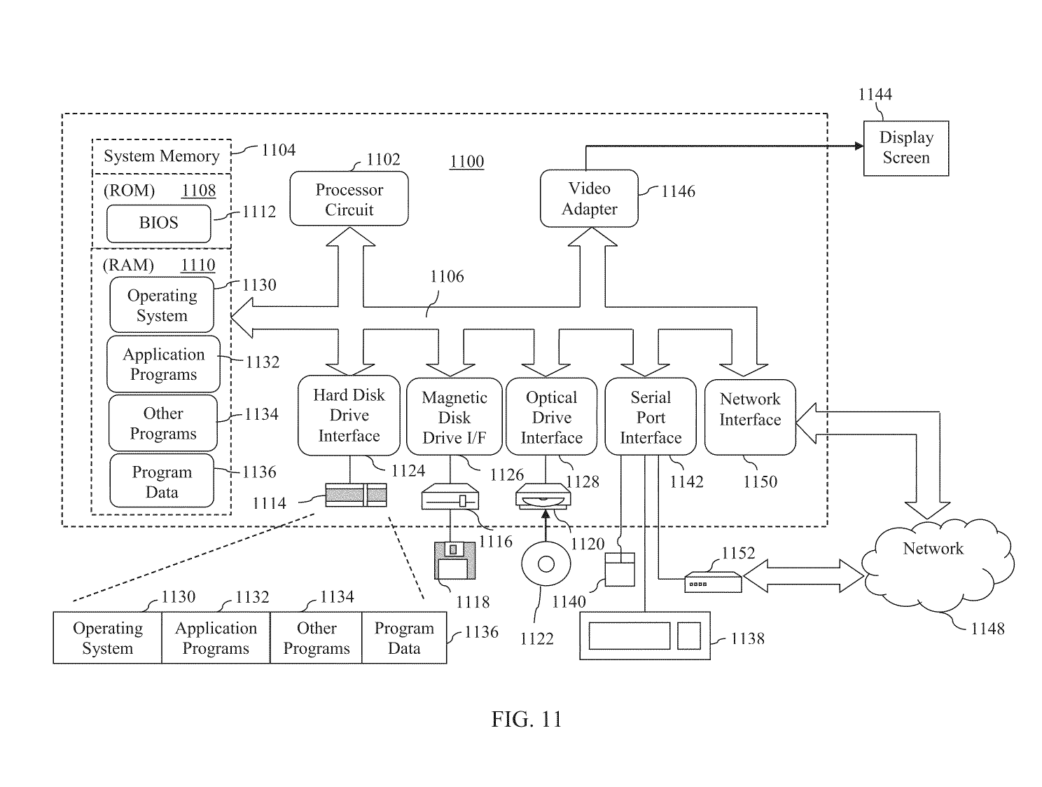

Furthermore, FIG. 11 depicts an exemplary implementation of a computing device 1100 in which embodiments may be implemented. For example, client device 102, server 104, server 106, and/or server 108 may be implemented in one or more computing devices similar to computing device 1100 in stationary computer embodiments, including one or more features of computing device 1100 and/or alternative features. The description of computing device 1100 provided herein is provided for purposes of illustration, and is not intended to be limiting. Embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couples various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136. Application programs 1132 or other programs 1134 may include, for example, computer program logic (e.g., computer program code or instructions) for implementing identity provider 112, authentication token generator 114, nonce generator 116, first service 118, proxy token generator 120, second service 122, hash generator 302, digital signature generator 304, token assembler 306, authenticator 502, hash generator 802, proxy token assembler 804, flowchart 200, flowchart 400, flowchart 600, flowchart 700, and/or flowchart 900 (including any suitable step of flowcharts 200, 400, 600, 700, 900), and/or further embodiments described herein.

A user may enter commands and information into the computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, etc.). In addition to display screen 1144, computing device 1100 may include other peripheral output devices (not shown) such as speakers and printers.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media (including memory 1020 of FIG. 10). Such computer-readable storage media are distinguished from and non-overlapping with communication media (do not include communication media). Communication media embodies computer-readable instructions, data structures, program modules or other data modulated in a data signal such as a carrier wave. The term “modulated data signal” means a signal that has one or more of its characteristics set or changed in such a manner as to encode information in the signal. Communication media embodies wireless media including acoustic, RF, infrared and other wireless media, as well as wired media. Embodiments are also directed to such communication media that are separate and non-overlapping with embodiments directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of embodiments discussed herein. Accordingly, such computer programs represent controllers of the computing device 1100.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

In one embodiment, a method in a first service is provided, the method comprising: receiving a user authentication token from a client device that was obtained from an identity provider, the user authentication token received to enable access to the first service by a user; authenticating the user based on the user authentication token; determining that a second service is to be accessed by the user; converting the user authentication token into a proxy token that is not convertible back to the user authentication token; forwarding the proxy token to the second service to enable access to the second service; and receiving a response from the second service due to the user having been authenticated based on the proxy token.

In an embodiment, the method further comprises: storing a server authentication object received from the identity provider that enables authentication of a first server that contains the first service; said forwarding comprises: forwarding the proxy token and the server authentication object from the first server to a second server to access the second service; and said receiving comprises: receiving the resource from the second service due to the second server having authenticated the user based on the proxy token and having authenticated the first server based on the server authentication object.

In an embodiment, the method further comprises: requesting the server authentication object from the identity provider; and storing the received server authentication object.

In an embodiment, the receiving a user authentication token from a client device comprises: receiving the user authentication token from the client device that was obtained from the identity provider, the user authentication token including data, a nonce that is a random number generated for the user authentication token, and an asymmetric digital signature of the data and the nonce.

In an embodiment, the asymmetric digital signature of the data and the nonce was generated at the identity provider by: performing a first cryptographic hash over the nonce to generate a first hash; performing a second cryptographic hash over the first hash and the data to generate a second hash; and digitally signing the second hash according to an asymmetric signature algorithm using a private key of a public and private key-pair associated with the user.

In an embodiment, the converting the user authentication token into a proxy token that is not convertible back to the user authentication token comprises: performing a first cryptographic hash over the nonce to generate a first hash; and forming the proxy token to include the data, the first hash, and the asymmetric digital signature.

In an embodiment, the receiving a response from the second service comprises: receiving a resource from the second service based on the second service having authenticated the user based on the proxy token.

In another embodiment, a first server comprises: an authenticator, a first service, and a proxy token generator. The authenticator is configured to authenticate users, the authenticator configured to receive user authentication tokens from client devices and to authenticate the users based on the user authentication tokens, the received user authentication tokens including a user authentication token received from a client device that was obtained by the client device from an identity provider. The first service is configured to perform at least one service for authenticated users, the user authenticated by the authenticator to access the first service based on the user authentication token, the first service configured to determine a second service to be accessed by the user. The proxy token generator is configured to convert the user authentication token into a proxy token that is not convertible back to the user authentication token, the proxy token configured to be forwarded to the second service to enable access to the second service. The first service is configured to receive a response from the second service due to the user having been authenticated based on the proxy token.

In an embodiment, a server authentication object is stored that enables authentication of the first server; the proxy token generator is configured to forward the proxy token and the server authentication object to the second service at a second server to access the second service; and the first service configured to receive the resource from the second service due to the second server having authenticated the user based on the proxy token and having authenticated the first server based on the server authentication object.

In an embodiment, the authenticator is configured to request the server authentication object from the identity provider and to store the received server authentication object.

In an embodiment, the user authentication token includes data, a nonce that is a random number generated for the user authentication token, and an asymmetric digital signature of the data and the nonce.

In an embodiment, to generate the asymmetric digital signature of the data and the nonce, the identity provider is configured to: perform a first cryptographic hash over the nonce to generate a first hash; perform a second cryptographic hash over the first hash and the data to generate a second hash; and digitally sign the second hash according to an asymmetric signature algorithm using a private key of a public and private key-pair associated with the user.

In an embodiment, to convert the user authentication token into a proxy token that is not convertible back to the user authentication token, the proxy token generator is configured to: perform a first cryptographic hash over the nonce to generate a first hash; and form the proxy token to include the data, the first hash, and the asymmetric digital signature.

In an embodiment, the first service is configured to receive a resource from the second service based on the second service having authenticated the user based on the proxy token.

In still another embodiment, a method in an identity provider is provided, the method comprising: receiving a request for a user authentication token from a client device for a user to use to access a first service; generating the user authentication token to include data, a nonce that is a random number, and an asymmetric digital signature of the data and the nonce; and forwarding the user authentication token to the client device, the user authentication token configured to be usable to authenticate the user, to enable the user to access the first service.

In an embodiment, the generating comprises: performing a first cryptographic hash over the nonce to generate a first hash; performing a second cryptographic hash over the first hash and the data to generate a second hash; and digitally signing the second hash according to an asymmetric signature algorithm.

In an embodiment, the digitally signing comprises: digitally signing the second hash according to an asymmetric signature algorithm using a private key of a public and private key-pair associated with the user.

In an embodiment, the user authentication token is convertible into a proxy token that is not convertible back to the user authentication token by: performing a first cryptographic hash over the nonce to generate a first hash; and forming the proxy token to include the data, the first hash, and the asymmetric digital signature.

In an embodiment, the proxy token can be forwarded to a second service by the first service for authentication of the user to enable the user to access the second service.

In an embodiment, the data at least includes: one or more claims about the user; an identifier for the identity provider; an identifier for the first service; and an expiration time of the token.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a first service, comprising:
receiving a user authentication token from a client device that was obtained from an identity provider, the user authentication token received to enable access to the first service by a user;
authenticating the user based on the user authentication token;
determining that a second service is to be accessed by the user;
converting the user authentication token into a proxy token that is not convertible back to the user authentication token;
forwarding the proxy token to the second service to enable access to the second service; and
receiving a response from the second service due to the user having been authenticated based on the proxy token.

2. The method of claim 1, further comprising:
storing a server authentication object received from the identity provider that enables authentication of a first server that contains the first service;
said forwarding comprises:
forwarding the proxy token and the server authentication object from the first server to a second server to access the second service; and
said receiving comprises:
receiving the resource from the second service due to the second server having authenticated the user based on the proxy token and having authenticated the first server based on the server authentication object.

3. The method of claim 2, further comprising:
requesting the server authentication object from the identity provider; and
storing the received server authentication object.

4. The method of claim 1, wherein said receiving a user authentication token from a client device comprises:
receiving the user authentication token from the client device that was obtained from the identity provider, the user authentication token including data, a nonce that is a random number generated for the user authentication token, and an asymmetric digital signature of the data and the nonce.

5. The method of claim 4, wherein the asymmetric digital signature of the data and the nonce was generated at the identity provider by:
performing a first cryptographic hash over the nonce to generate a first hash;
performing a second cryptographic hash over the first hash and the data to generate a second hash; and
digitally signing the second hash according to an asymmetric signature algorithm using a private key of a public and private key-pair associated with the user.

6. The method of claim 4, wherein said converting the user authentication token into a proxy token that is not convertible back to the user authentication token comprises:
performing a first cryptographic hash over the nonce to generate a first hash; and
forming the proxy token to include the data, the first hash, and the asymmetric digital signature.

7. The method of claim 1, wherein said receiving a response from the second service comprises:
receiving a resource from the second service based on the second service having authenticated the user based on the proxy token.

8. A first server, comprising:
an authenticator configured to authenticate users, the authenticator configured to receive user authentication tokens from client devices and to authenticate the users based on the user authentication tokens, the received user authentication tokens including a user authentication token received from a client device that was obtained by the client device from an identity provider;
a first service configured to perform at least one service for authenticated users, the user authenticated by the authenticator to access the first service based on the user authentication token, the first service configured to determine a second service to be accessed by the user; and
a proxy token generator configured to convert the user authentication token into a proxy token that is not convertible back to the user authentication token, the proxy token configured to be forwarded to the second service to enable access to the second service; and
the first service configured to receive a response from the second service due to the user having been authenticated based on the proxy token.

9. The first server of claim 8, wherein a server authentication object is stored that enables authentication of the first server;
the proxy token generator configured to forward the proxy token and the server authentication object to the second service at a second server to access the second service; and
the first service configured to receive the resource from the second service due to the second server having authenticated the user based on the proxy token and having authenticated the first server based on the server authentication object.

10. The first server of claim 9, wherein the server authentication object is a server authentication token, and the authenticator is configured to request the server authentication token from the identity provider and to store the received server authentication token.

11. The first server of claim 9, wherein the server authentication object is a client certificate.

12. The first server of claim 8, wherein an IP (Internet Protocol) access control list is accessed to enable authentication of the first server.

13. The first server of claim 8, wherein the user authentication token includes data, a nonce that is a random number generated for the user authentication token, and an asymmetric digital signature of the data and the nonce.

14. The first server of claim 13, wherein to generate the asymmetric digital signature of the data and the nonce, the identity provider is configured to:
perform a first cryptographic hash over the nonce to generate a first hash;
perform a second cryptographic hash over the first hash and the data to generate a second hash; and
digitally sign the second hash according to an asymmetric signature algorithm using a private key of a public and private key-pair associated with the user.

15. The first server of claim 13, wherein to convert the user authentication token into a proxy token that is not convertible back to the user authentication token, the proxy token generator is configured to:
perform a first cryptographic hash over the nonce to generate a first hash; and
form the proxy token to include the data, the first hash, and the asymmetric digital signature.

16. A method in an identity provider, comprising:
receiving a request for a user authentication token from a client device for a user to use to access a first service;
generating the user authentication token to include data, a nonce that is a random number, and an asymmetric digital signature of the data and the nonce; and
forwarding the user authentication token to the client device, the user authentication token configured to be usable to authenticate the user, to enable the user to access the first service.

17. The method of claim 16, wherein said generating comprises:
performing a first cryptographic hash over the nonce to generate a first hash;
performing a second cryptographic hash over the first hash and the data to generate a second hash; and
digitally signing the second hash according to an asymmetric signature algorithm.

18. The method of claim 17, wherein said digitally signing comprises:
digitally signing the second hash according to an asymmetric signature algorithm using a private key of a public and private key-pair associated with the user.

19. The method of claim 17, wherein the user authentication token is convertible into a proxy token that is not convertible back to the user authentication token by:
performing a first cryptographic hash over the nonce to generate a first hash; and
forming the proxy token to include the data, the first hash, and the asymmetric digital signature.

20. The method of claim 19, wherein the proxy token can be forwarded to a second service by the first service for authentication of the user to enable the user to access the second service.
